(19) United States
(12) Patent Application Publication
(10) Pub. No.: US 2009/0322085 A1
(43) Pub. Date: Dec. 31, 2009

(54) METHOD AND APPARATUS FOR ENHANCED WIND TURBINE DESIGN

(76) Inventor: Regis P. Renaud, Silverado, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/487,603

(22) Filed: Jun. 18, 2009

Related U.S. Application Data
(60) Provisional application No. 61/073,707, filed on Jun. 18, 2008.
(60) Provisional application No. 61/081,679, filed on Jul. 17, 2008.

(51) Int. Cl. H02P 9/04

(52) U.S. Cl. 290/44

(57) ABSTRACT

An improved wind turbine system can have a generator or set of generators at the base of a tower and one or more sets of propeller hubs at the top of the tower. The sets of propeller hubs can be on opposite sides of the tower to account for the reduction in weight from having the generators at the base of the tower. The wind turbine system can have a conveyor system to move parts of the tower and/or the propeller hubs up and down to thereby reduce the height of the system for installation and maintenance purposes. Transmissions can be coupled to the propeller hubs to adjust the torque load on the turbines depending on the amount of wind. Additional generators can be connected to the propeller hub to increase the torque load.

### CROSS-REFERENCE TO RELATED APPLICATIONS

This application claims the benefit under 35 U.S.C. § 119(e) of U.S. Provisional Application No. 61/073,707, filed Jun. 18, 2008 and U.S. Provisional Application No. 61/081,679, filed Jul. 17, 2008, the entire contents of all of which are hereby incorporated by reference herein and made a part of this specification.

### BACKGROUND OF THE INVENTION

1. Field of the Invention

Embodiments of the present invention relate to an enhancement over many of the wind turbines in use today.

2. Description of the Related Art

The standard wind turbine contains a single two or three bladed propeller hub mounted to a generator that weighs 20 to 90 tons to help resist the torque of the propellers. Many current installations require a crane over 250 feet tall to install the generator and hub on top of a wind tower. The cost of renting and using a crane of this type is very expensive and can cost over $100,000 per day.

### SUMMARY OF THE INVENTION

Some embodiments include one or more of the following unique modifications to current types of wind turbines:

Move the generator unit from the top of the tower lower to, for example, the base of the tower. Additional generators may be installed at the base of the tower and connected to the rotor hubs.

Install a matching second propeller hub opposite the original hub and propeller. The opposing propellers can rotate in the same direction or counter-rotate and can include two, three, or more propellers. In some embodiments, the following propeller may be larger than the leading propeller to recover additional force from the wind. The one or more propeller hubs can be connected with, for example, a differential gear box and a hard driveshaft to a generator.

The propeller hubs can be mounted on one or more platform(s) that can move up and down the tower and can be raised and lowered by a cable, gear, or other system. The hub platform would preferably be moved to the height necessary to install or perform maintenance on the propellers. This change, from performing most all of this work at the top of the tower to a much lower height, could allow for the use of a smaller crane, for example one that is only half the size and costs a fraction of that used currently. A winch or gear system or other system could be used to raise the platform to the top of the tower once the work on the propellers and hubs are complete.

Install one or more generators to be connected one at a time or in parallel or in series to match the current wind conditions. The generators can have various sizes and can be installed at the base of the tower. The driveshaft can be connected to a transmission to direct torque to the generation system, gears can be changed to match torque and revolutions per minute to match the wind conditions.

A power takeoff from the transmission can be used to store some power being generated in a potential energy system. The potential energy system can be configured to drive the generators for a period of time after the wind speed drops below a certain threshold level. In some embodiments, the potential energy system includes heavy weights configured to be lifted to an elevated position by the power takeoff. The energy from the movement of the weights from the elevated position to the ground can drive the generators after the wind speed drops below a threshold level. The heavy weights can also provide stability to the tower during high wind conditions.

A power management system can control the transmission system to maximize energy production.

As mentioned previously, the various embodiments can include, but are not limited to, one or more of the above modifications. Some additional examples include the following.

A method of adjusting the torque load on a wind turbine rotor in accordance with wind conditions can comprise providing a wind turbine having a rotor assembly, a differential, a transmission and a power management system and providing a set of generators wherein the rotor assembly is connected to the differential and the transmission to convey torque from the rotor assembly to at least one generator in the set of generators. The method can further involve applying a torque load on the rotor assembly from the at least one generator and generating electricity with the at least one generator. Some embodiments of the method comprise increasing the torque load on the rotor assembly in response to an increase in wind speed. This can comprise engaging one or more additional generators of the set of generators to increase the torque load on the rotor assembly. These generators can be connected in series, in parallel, or some combination of both.

According to certain embodiments, the method further comprises disengaging the at least one generator wherein the one or more additional generators providing a larger load on the rotor assembly then the at least one generator. Increasing the torque load on the rotor assembly can comprise slowing the rotation of the rotor assembly and keeping it within operating revolutions during high wind conditions. This can also be such that the rotor assembly does not have to be feathered.

Certain embodiments can comprise decreasing the torque load on the rotor assembly in response to a decrease in wind speed. Increasing or decreasing the torque load on the rotor assembly can comprise engaging a different sized generator from the at least one generator to change the torque load on the rotor assembly to keep it within operating revolutions. Alternatively, or in addition, increasing or decreasing the torque load on the rotor assembly can comprise changing a gear ratio in the transmission.

Some embodiments can further comprise engaging a second rotor assembly of a second wind turbine with the at least one generator and still further increasing or decreasing the torque loads on both the rotor assembly and the second rotor assembly in response to an increase or decrease in wind speed, respectively.

Additional embodiments of a method can comprise providing a power takeoff on the wind turbine, a cable on a spool, a pulley system and a weight, wherein the cable on the spool is connected to the power takeoff and the transmission of the wind turbine; raising the weight to a top of the wind turbine by rotating the spool with the power takeoff; lowering the weight; and generating electricity with the at least one generator, wherein the lowering of the weight causes the at least one generator to generate electricity. The power takeoff can be engaged to raise the weight when additional load is required to keep the rotor at the desired rotations per minute during strong winds.

A wind turbine system can comprise a tower, a rotor assembly mounted on the tower, a set of generators, a differential, a transmission and a power management system. The set of generators can be configured to generate electricity from the rotation of the rotor assembly, wherein the set of generators are at a base of the tower and have a first configuration with a first load on the rotor assembly and a second configuration with a second load on the rotor assembly greater than the first. The rotor assemblies can be connected to the differential and the transmission to convey torque from the rotor assembly to the set of generators. The transmission and the set of generators can be controlled by the power management system and configured to adjust the load experienced by the rotor assembly depending on the wind conditions.

There can be various configurations of the set of generators. For example, in the first configuration a first generator can be connected to the rotor assembly to generate energy. As a further example, in the second configuration a second generator can be connected to the rotor assembly to generate energy together with or instead of the first generator. Additionally, the first and second configurations can refer to different groups of generators connected to the rotor assembly to generate energy.

A wind turbine system can comprise: a tower, a first rotor assembly, a movable platform configured to move up and down the tower, wherein the first rotor assembly is mounted on the movable platform and a generator configured to generate electricity from the rotation of the first rotor assembly. Some embodiments of a wind turbine system can further comprise a second rotor assembly on an opposite side of the tower from the first rotor assembly. The second rotor can be on the same platform or on a different platform from the first rotor assembly.

In some embodiments, the wind turbine system can further comprise a counterweight system comprising a power takeoff and a counterweight, wherein the power take off is configured to utilize some of the energy from the rotation of the rotor assemblies to raise the counterweight.

A method of storing potential energy for use with a wind turbine tower when the wind drops below a threshold level can comprise providing a power management system, a generator, a cable on a spool, a pulley system and a weight, wherein the cable on the spool is connected to a power takeoff and a transmission of the wind turbine tower, and the transmission is connected to a rotor on the wind turbine tower. The method can further comprise raising the weight to a top of the wind turbine tower by rotating the spool with the power takeoff, lowering the weight and generating electricity with the generator, wherein the lowering of the weight causes the generator to generate electricity.

According to certain embodiments, in the method the power takeoff is engaged to raise the weight when additional load is required to keep the rotor at the desired rotations per minute during strong winds. Also, certain methods may comprise engaging one or more additional generators to add torque load to the one or more rotors to slow their rotation and keep them within operating revolutions during high wind conditions.

A method of assembling a wind turbine tower by telescoping the components of the tower in segments can comprise providing multiple tower segments, one inside the other and a conveyor system, conveying an a first segment of the multiple tower segments into a position above a second segment and fastening the first segment to the second segment. The method can further comprise conveying one or more additional segments into a position above their prior position and fastening the one or more additional segments to another segment.

### BRIEF DESCRIPTION OF THE DRAWINGS

Some embodiments illustrating various potential features, will now be discussed in greater detail. These embodiments depict the novel and non-obvious method of improving the efficiency of construction and operation of the invention shown in the accompanying drawings, which are for illustrative purposes only. These drawings include the following figures, in which like numerals indicate like parts:

FIG. 1 is a schematic front view of an apparatus according to one embodiment.

FIG. 2 is a schematic side view of the apparatus of FIG. 1.

FIG. 3 is a schematic side view of an apparatus according to another embodiment.

FIG. 4 is a schematic side view of an apparatus with a single differential and driveshaft.

FIG. 5 is a schematic plan view of a self-raising platform showing one layout of a driveshaft differential system and the connections to the hubs.

FIG. 6 is a schematic plan view of a self-raising platform showing one layout of another embodiment of a driveshaft differential system and the connections to the hubs.

FIG. 7 is a schematic side view of an embodiment of a counterweight system.

FIG. 8 is a schematic side view of a self-rising telescoping tower according to some embodiments.

FIG. 9 is a schematic front view of an apparatus according to another embodiment.

FIG. 10 is a schematic side view of the apparatus of FIG. 9.

FIG. 11 is a schematic side view of an apparatus with a hydraulic pump according to some embodiments.

FIG. 12 is a schematic plan view of a self-raising platform showing one layout of a hydraulic system and the connections to the hubs according to some embodiments.

FIG. 13 is a schematic plan view of a self-raising platform showing one layout of another embodiment of a hydraulic system and the connections to the hubs.

FIG. 14 is a schematic side view of another embodiment of a counterweight system.

### DETAILED DESCRIPTION

In some embodiments of a wind turbine system, a generator can be relocated from a top of a tower to the base of the tower. The wind turbine system can be manufactured to have the generator at the base or a preexisting wind turbine system can be retrofitted to allow the generator to be moved to the base of the tower. In some embodiments, a second hub, with for example two or three propellers can be placed on the opposite side of the tower from the first hub to counter balance the first set of propellers. The two sets of propellers can be configured to counter-rotate or rotate in the same direction. In some embodiments, the propeller blades can be shortened by half and still have the same thrust potential as the original wind turbine system with only one hub or they can remain the same size as their standard equivalent and double the torque.

Currently, when the wind is blowing harder than the turbines can handle, the props or blades are feathered or rotated out of line with the wind to reduce torque and to maintain a predetermined rotational rate, for example 14 rotations per minute on large rotors and 47 rotations per minute on smaller rotors. Moving the generators away from the hubs, for example and placing the generators at the base of the tower can allow for any number or size of generators to be installed in the system. As the wind speed increases, the additional units can be connected to a drive system connected to the propeller hubs, increasing the load and slowing the propellers. The generators can be various sizes to better match the wind conditions. This can allow more efficient usage of the wind conditions rather than cutting back on torque by feathering the blades.

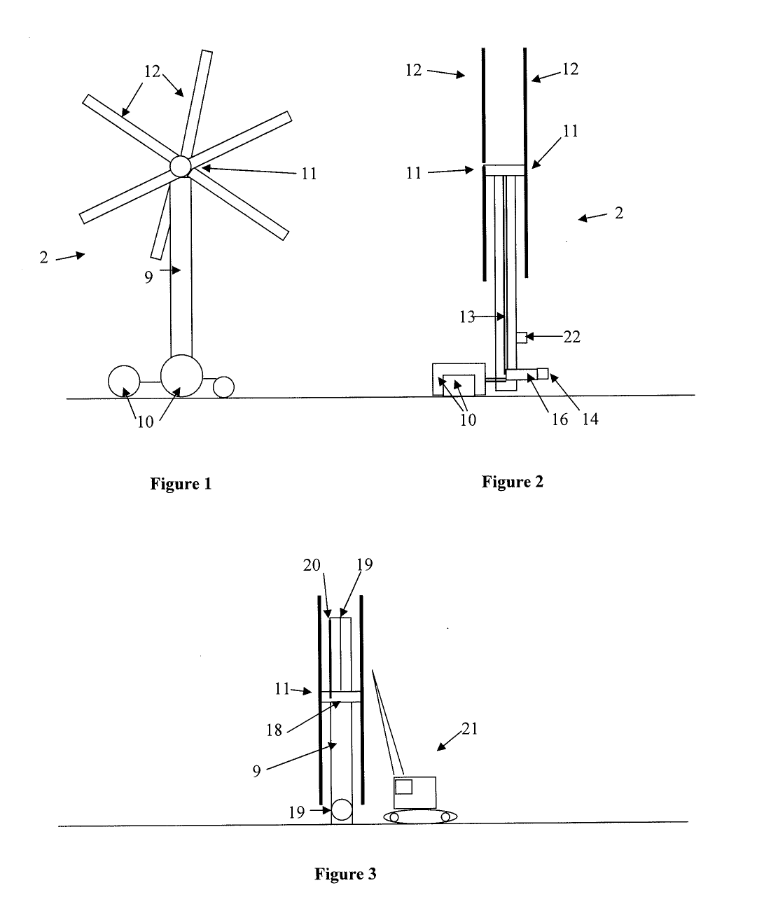

FIGS. 1 and 2 schematically illustrate an apparatus according to certain embodiments of a wind turbine system 2 for performing certain of the methods described herein. A wind turbine 2 can have a generator 10, tower 9, a propeller hub 11 and blades 12. FIG. 1 illustrates six blades with two sets of opposing propeller hubs 11. Various sized generators 10 are shown at the base of the tower 9. The propeller hubs 11 are connected to the generator(s) 10 by a driveshaft 13 and transmission 16.

In some embodiments, a wind turbine can be modified by relocating the generator 10 to the base of the tower. A single hub and propeller system 11 can be balanced by installing another hub and propeller system 11 on the opposite side of the tower 9. The propellers 11 can counter rotate or they can rotate in the same direction. In some embodiments, the two hubs share a rotational axis.

FIG. 2 presents an embodiment including two opposing hubs 11 and showing the schematic connection of the driveshaft 13 to the two opposing hubs 11 and to a transmission 16. It also shows the generators 10 at the base of the tower and one or more transmissions 16 connecting the driveshaft 13 to the generators 10. The transmission 16 may have various gear ratios to adjust to changes in wind velocity. A power management system 22 is also shown. The power management system 22 can be used to interconnect multiple wind turbines 2 and/or multiple generators 10. In some embodiments, the power management system 22 can also control the gear ratios of the transmission 16.

The driveshaft 13 is shown connected to a transmission 16 that can transmit power to one or more generators 10 of various sizes to match increased variations in wind conditions. For example, various generators 10 can be configured to connect in series on an on demand basis. As the wind speed increases, more generators 10 can come online, thereby increasing the load on the wind turbine and maintaining or altering the speed of the blades 12. For example, the additional load may slow the speed of the blades 12. The generators 10 can also be configured to be connected in parallel or some other configuration such as in preselected clusters or groups. In some embodiments, different sized generators 10 may be available to a particular wind turbine. Thus, in some embodiments, a first smaller generator may be disengaged and a larger generator engaged in its place. In some embodiments, the wind turbine can be connected to one group of generators under one set of conditions and can be connected to a different group of generators under a second set of conditions. In some embodiments a network of wind turbines can be connected to one system of generators such that the turbines can share the generators 10 and thereby share resources. This could be well suited for an area that, for example, frequently experiences changes in the wind's direction and different wind turbines are likely to be exposed to different levels of wind at different times.

As will be described in more detail below, when excess wind is producing excess torque, a power take-off 14 on or connected to the transmission 16 can increase the load on the system to utilize the excess torque. For example, a power takeoff 14 on the transmission 16 can turn a cable and spool to lift a counterweight 24 up into a tower 9 (FIG. 7). When wind speed is low, the stored potential energy in the counterweights 24 can be converted to kinetic energy to extend the generator's operation by lowering the counterweights 24 to the ground and thereby driving the generators. A power management system 22 can be used to maximize the output of each tower and generating system.

As can be seen in FIG. 3, a wind turbine system 2 with one or two propeller hubs 11 can be placed on one or two movable platforms 18 that slide up and down the tower 9. This can be independent of whether or not the generator 10 is at the base of the tower 9 or somewhere else along the tower 9. In some embodiments, this platform 18 can be raised or lowered by for example, a cable and winch system 19 and/or a gear and track system 20. The platform 18 could be raised high enough to allow the propeller blades 12 to be attached to the hub 11. In some embodiments, the platform 18 could be raised to approximately half the height of the tower, allowing the use of a crane 21 less than half the size of that used previously, thereby saving costs for installation and maintenance.

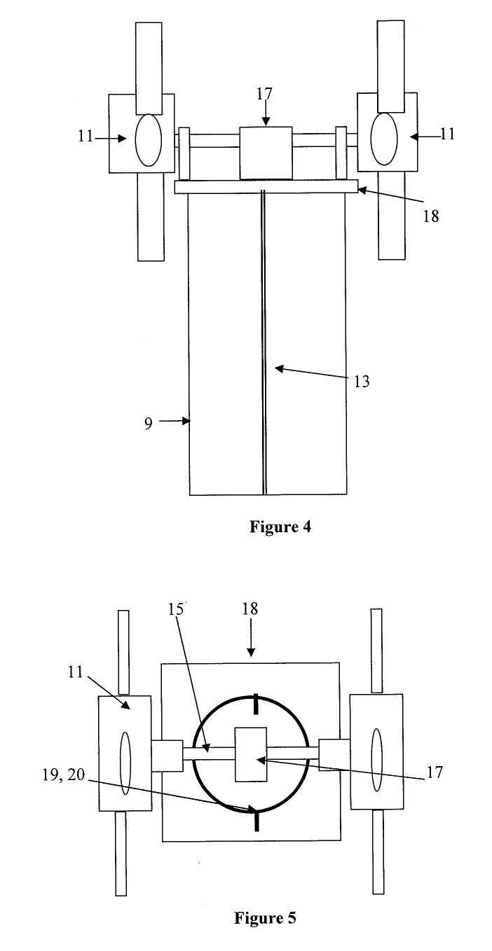

FIG. 4 presents one embodiment of a single differential system 17 to convey the propeller hub torque from both hubs 11 to the generator 10 and transmission 16. A movable platform 18 is shown, though other embodiments are on a fixed platform (not shown). The hubs 11 can transmit torque to the differential system 17 which can in turn transmit torque to the driveshaft 13. The driveshaft 13 can transmit torque to the transmission 16 and thereby to the generator 10.

FIG. 5 illustrates a plan view of a single differential system 17 connected to the hubs 11 by a common shaft 15. A single driveshaft could transmit the torque to the transmission 16 connected to the generators 10. A conveyor system is also schematically shown, such as a cable and winch system 19 or a gear track system 20, that can raise or lower the moveable platform 18.

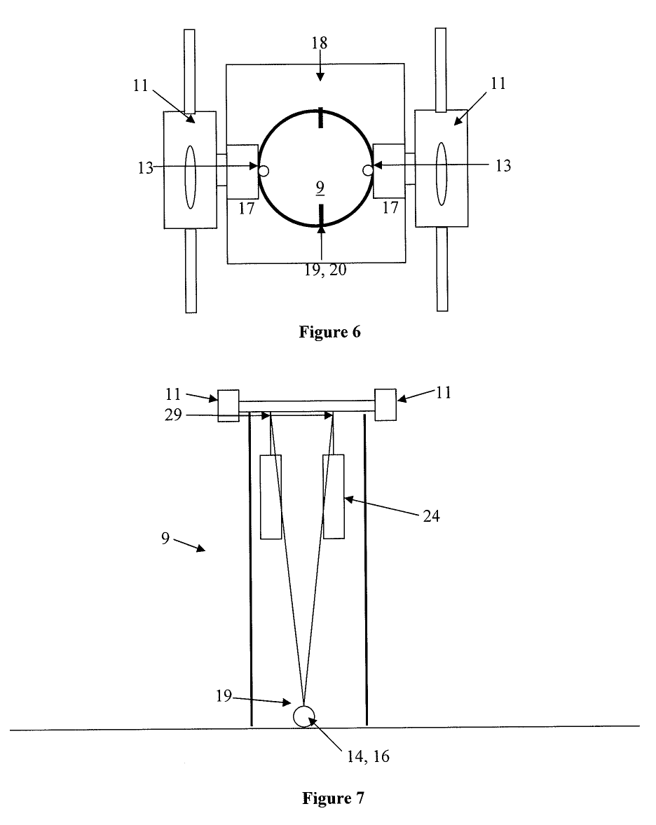

FIG. 6 presents a plan view of an embodiment similar to that of FIG. 5 except that each hub 11 is connected to separate differential 17 and driveshaft 13. These separate driveshafts 13 can be connected to the same or to separate transmissions 16 and/or generators 10.

Turning now to FIG. 7, a means of storing energy from the wind to be used when the wind drops below a threshold is illustrated. Although wind turbines are usually placed in high wind areas, the wind occasionally does stop blowing. During these times, the turbines set idle and no power or revenue is being generated. When excess torque is generated by strong winds and some or all of the generators are on line, in some embodiments, the extra torque can be utilized by connecting to a power takeoff 14 of the transmission 16. The power takeoff 14 can utilize the extra torque to increase the load on the system while storing energy for later use so that the props 12 do not have to be feathered. In certain embodiments, the threshold is when the wind speed slows below that required to rotate the wind turbine. In some embodiments, the threshold can be slightly above this level of wind speed.

In some embodiments, the power takeoff 14 is connected to a cable spool, which hoists one or more counterweights 24 up into the tower 9 by way of, for example, pulleys 29. In some embodiments, the counterweights 24 can be, for example, several tons, and/or the weight potentially being varied to accommodate different application parameters. When the wind drops below the threshold (in some embodiments determined by the amount of wind required to rotate the blades of the turbine), the weights 24 can be configured to begin to fall. The movement downwards can turn the power takeoff 14 on the transmission 16 and may turn one or more of the generators 10 until the weights hit the ground or the wind starts blowing again, whichever comes first.

As an added benefit, the action of raising the weights up into the tower can put the tower in compression. This can provide stability against strong winds and the turbulence from the rotating rotors 11. With the weights 24 in the upper portion of the tower, they can advantageously counter the sway of the tower during high wind conditions. A power management system 22 can control the system to maximize energy production. In some embodiments, one or more counterweight systems can be used to keep the generators operating when the wind stops blowing perhaps for hours.

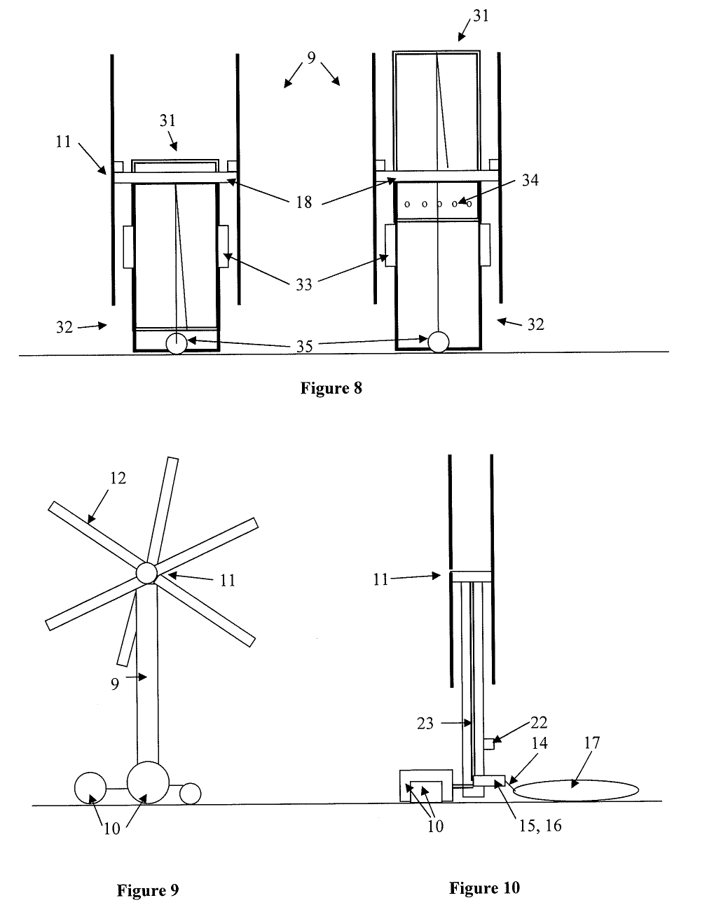

Referring to FIG. 8, in some embodiments it may be advantageous to construct a tower 9 with two or more sections and/or a self-raising platform. For example, with the. generator moved off the tower and placed on the ground, in some embodiments the towers can be of lighter construction this can allow new construction of wind turbine towers to be constructed in segments.

One or more conveyer systems can be used to move the sections and/or a self-raising platform into their finished positions. In some embodiments, the tower 9 can be constructed in segments on site where the top half of the tower 31 could be constructed inside the lower half of the tower 32 in two or more sections. In some embodiments, the towers in question are hundreds of feet tall. In some embodiments, the sections can be approximately 20 or more feet in length. In some embodiments, the sections are approximately 40 or more feet in length. In some embodiments, the sections are approximately 100 or more feet in length. The top section 31 can be raised above the lower section 32 by way of one or more conveyer systems, for example a pulley and cable system 35 or a gear and track system 33. The top section 31 can overlap the lower section 32 by sufficient length to provide the necessary support for the expected loads and can be bolted 34 or otherwise joined to the lower section 32.

In some embodiments, where the wind turbine system has both two or more sections and a self-raising platform, once the tower 9 is raised to the vertical position, a conveyer system can be used to bring the self-raising platform 18 into a final position at or near the top of the tower 9. In some embodiments, the orientation of the tower sections can be switched with the lower section positioned within the top section. In some embodiments, additional sections may be used to facilitate construction. In some embodiments the conveyor system used to raise and/or lower the sections and/or the platform can also be used as part of the counterweight system described previously.

FIGS. 9-14 illustrate modified embodiments of a wind turbine system where a hydraulic system is used in place of the driveshaft 13 as will be explained in more detail below.

FIGS. 9 and 10 schematically illustrate an apparatus having opposing propellers 12 on propeller hubs 11 connected to one or more generators 10 by a hydraulic system 23 and motor system 15. The hydraulic system 23 can comprise a system with various pumps, lines, hoses, and pipes etc. FIG. 10 also shows the torque connection to the generators 10 and the pressure connection to the accumulator system 17.

The hydraulic system 23 can also be connected to a transmission 16 that can transmit power to one or more generators 10 of various sizes to match increased variations in wind conditions. When excess wind is producing excess torque, the hydraulic system 23 can send excess oil pressure to an accumulator 17. When wind speed is low, the stored energy in the accumulator can extend the generator's operation. As in the embodiment discussed above, the stored hydraulic energy can be shared by one or more towers 9 in a network and a power management system 22 can be used to maximize the output of each tower 9 and generating system.

Some embodiments can further comprise a power takeoff 14 from the transmission that can send excess torque to a hydraulic accumulator 17 or other device to store energy for when the wind stops blowing. In some embodiments this can allow the generator 10 to continue to turn for a period of time.

When high winds are producing excess torque, a power takeoff 14 on the transmission 16 can transmit the excess torque to an accumulator 17 to store energy. When the wind speed is low, the stored energy can maintain the generators at the proper speed. The hydraulic system 23 can also be connected to other windmills in the wind farm so that any excess torque can be directed to the accumulators 17 in the network. This can maintain steady energy production in varying wind conditions. Also, if a generator set 10 at one tower 9 is needed to be shut down for maintenance, the torque from this tower 9 could be transmitted to other generator sets 10 in the network. A power management system 22 can control the system to maximize energy production. A similar situation can be used in the embodiments described above where the torque from the tower is transmitted to the generators by way of driveshafts rather than hydraulic systems.

Turning now to FIGS. 11-13, various configurations of a tower 9 with a hydraulic system 23 are shown. In some embodiments, as shown in FIG. 11, the propeller hubs 11 can be connected to the generator sets 10 by hydraulic hoses/pipes 25 attached to a pump 27 at the hub 11 and to a hydraulic motor 4 and/or a transmission 16 at the generator sets 10 (not shown).

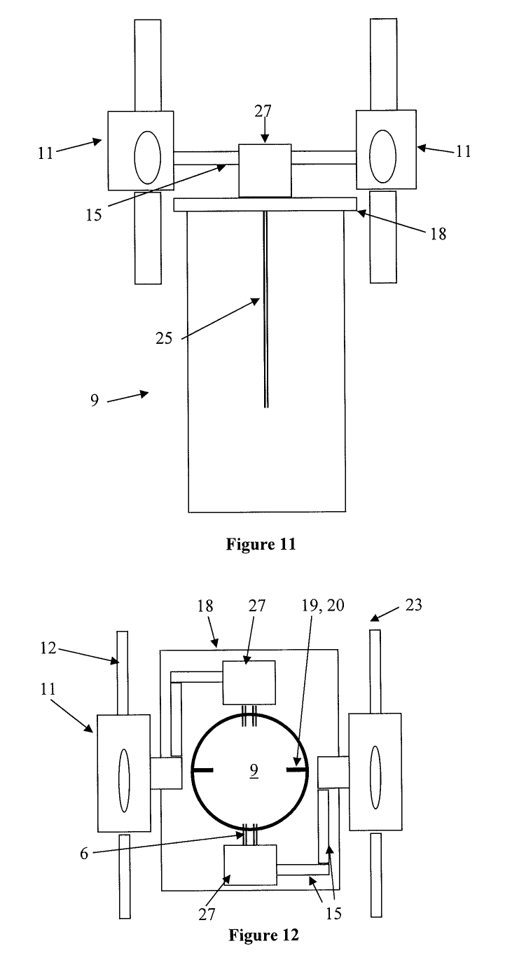

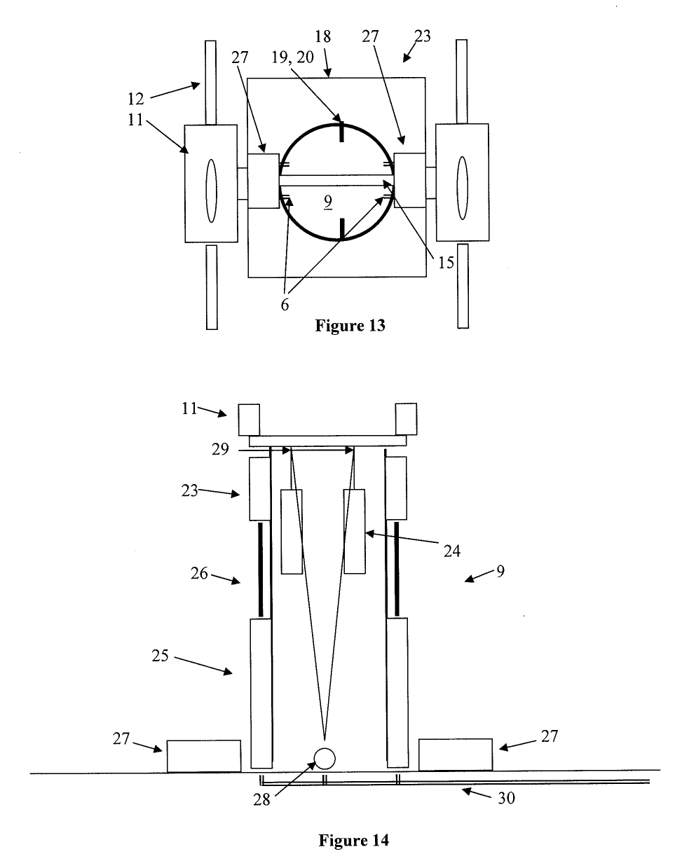

FIGS. 12 and 13 are schematic plan views of additional hydraulic systems 23. In FIG. 12, hydraulic pumps 27 are connected to the individual propeller hubs 11 via shafts 15. Hydraulic lines 6 connect the pumps 27 to the generator(s) 10 (not shown). In FIG. 13, hydraulic pumps 27 are directly connected to the propellers hubs 11. An optional shaft 15 connecting the hydraulic pumps 27 is also shown.

As previously discussed, the wind occasionally stops blowing or blows below a threshold level, resulting in a potentially idle wind turbine where no power or revenue is being generated. As will be detailed referring to FIG. 14, in some embodiments, one or more counterweight systems can be used in addition to or instead of the accumulator 17 to keep the generator 10 operating for at least a time in low or no wind conditions.

When excess torque is generated by strong winds and some or all of the generators 10 are on line, in some embodiments, the extra oil pressure and oil flow may turn another pump/motor 28 connected to a cable spool. This extra energy can be used for different purposes. One example is to hoist one or more counterweights 24 up into the tower 9 by way of, for example, pulleys 29 (FIG. 14). Another embodiment could have the counterweights 24 outside the tower or both inside and outside for extra energy storage. The counterweight and pulley system could use the excess pressures to lift the heavy weights into the air thereby storing potential energy.

In some embodiments, the counterweights 24 can be, for example, several tons, the weight potentially being varied to accommodate different application parameters. Then, in low to no wind conditions, the weights 24 can begin to fall. This downward movement can turn the motor/pump 28 and may turn one or more of the generators 10 until the weights hit the ground or the wind picks up, whichever comes first. In this way the wind turbine can continue to generate power and revenue even in low to no wind conditions.

The counterweight systems disclosed herein can be used, alone or in combination with each other or additional systems, for example the accumulators described above, to store excess energy.

Other accumulators can be employed as well, either alone or in combination. For example, in some embodiments, some or all of the excess oil pressure and oil flow can be sent to an inverted hydraulic cylinder 25, with empty tank 23 on top of the ram 26. Once the cylinder 25 is raised to its full stroke the tank 23 could be filled with liquid pumped up from a holding tank 27. The tank 23, now full of liquid can apply a heavy load onto the ram 26 and thereby onto a hydraulic fluid. This pressurized hydraulic fluid can be used to operate the generator 10 during no wind or low wind conditions.

As shown in FIG. 14, once the rams 26 are extended to their full-length, liquid, for example water and/or antifreeze, is pumped up into the tanks 23 via hoses and pumps from holding tanks 27 on the ground, applying tons of force to the oil in the cylinders 25. Once the oil is drained out of the cylinders 25, the empty tank 23 can then be raised up on top of the ram to the full stroke of the cylinder when excess torque is again generated by the wind turbine.

Embodiments of these systems can allow potential energy to be stored during low to high wind conditions as determined by the energy management system 22. Once the wind ceases to blow or decreases to some other threshold level, the stored energy may be used to turn the generators or the oil can be sent to other wind turbines in the network via pipeline 30.

The various modifications described herein should reduce certain costs associated with the installation and maintenance of the tower and in some instances the reductions can be by more than half. For example, the very large crane currently being used is a major cost of installation and by making the hub platform moveable, alone or in combination with moving the one or more generators to the base of the tower can require a much smaller crane, thereby reducing costs significantly. In some embodiments, the added costs of the torque transfer system should be offset by the additional power being generated at a longer and more constant rate. Operations and maintenance of the system should be much lower with the major components being on the ground instead of 250 feet in the air.

The above presents a description of the best mode contemplated for carrying out the present invention, and of the manner and process of making and using it, in such full, clear, concise, and exact terms as to enable any person skilled in the art to which it pertains to make and use this invention. Embodiments of this invention are, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the present disclosure.

What is claimed is:

1. A method of adjusting the torque load on a wind turbine rotor in accordance with wind conditions comprising:
providing a wind turbine having a rotor assembly, a differential, a transmission and a power management system;
providing a set of generators wherein the rotor assembly is connected to the differential and the transmission to convey torque from the rotor assembly to at least one generator in the set of generators;
applying a torque load on the rotor assembly from the at least one generator;
generating electricity with the at least one generator; and
increasing the torque load on the rotor assembly in response to an increase in wind speed, comprising engaging one or more additional generators of the set of generators to increase the torque load on the rotor assembly.

2. The method of claim 1, further comprising disengaging the at least one generator wherein the one or more additional generators providing a larger load on the rotor assembly then the at least one generator.

3. The method of claim 1, further comprising decreasing the torque load on the rotor assembly in response to a decrease in wind speed.

4. The method of claim 3, wherein increasing or decreasing the torque load on the rotor assembly comprises engaging a different sized generator from the at least one generator to change the torque load on the rotor assembly to keep it within operating revolutions.

5. The method of claim 1, wherein increasing the torque load on the rotor assembly comprises slowing the rotation of the rotor assembly and keeping it within operating revolutions during high wind conditions.

6. The method of claim 1, wherein increasing the torque load on the rotor assembly comprises slowing its rotation so that it does not have to be feathered and keeping it within operating revolutions during high wind conditions.

7. The method of claim 1, wherein the at least one generator and the one or more additional generators are connected in series.

8. The method of claim 1, wherein the at least one generator and the one or more additional generators are connected in parallel.

9. The method of claim 3, wherein increasing or decreasing the torque load on the rotor assembly further comprises changing a gear ratio in the transmission.

10. The method of claim 1, further comprising engaging a second rotor assembly of a second wind turbine with the at least one generator.

11. The method of claim 10, further comprising increasing or decreasing the torque loads on both the rotor assembly and the second rotor assembly in response to an increase or decrease in wind speed, respectively.

12. A method of adjusting the torque load on a wind turbine rotor in accordance with wind conditions comprising:
providing a wind turbine having a rotor assembly, a differential, a transmission and a power management system;
providing a set of generators wherein the rotor assembly is connected to the differential and the transmission to convey torque from the rotor assembly to at least one generator in the set of generators;
applying a torque load on the rotor assembly from the at least one generator;
generating electricity with the at least one generator;
increasing the torque load on the rotor assembly in response to an increase in wind speed, comprising engaging one or more additional generators of the set of generators to increase the torque load on the rotor assembly; and
providing a system for converting excess torque from the rotor assembly to potential energy, the system configured to use the potential energy to thereby drive one or more generators of the set of generators when the wind speed drops below a predetermined level.

13. The method of claim 12, further comprising:
providing a power takeoff on the wind turbine, a cable on a spool, a pulley system and a weight, wherein the cable on the spool is connected to the power takeoff and the transmission of the wind turbine;
raising the weight to a top of the wind turbine by rotating the spool with the power takeoff;
lowering the weight; and
generating electricity with the at least one generator, wherein the lowering of the weight causes the at least one generator to generate electricity.

14. The method of claim 13, wherein the power takeoff is engaged to raise the weight when additional load is required to keep the rotor at the desired rotations per minute during strong winds.

15. A wind turbine system comprising:
a tower;
a rotor assembly mounted on the tower;
a set of generators configured to generate electricity from the rotation of the rotor assembly, wherein the set of generators are at a base of the tower and having a first configuration with a first load on the rotor assembly and a second configuration with a second load on the rotor assembly greater than the first;
a differential;
a transmission, wherein the rotor assemblies are connected to the differential and the transmission to convey torque from the rotor assembly to the set of generators; and
a power management system, wherein the transmission and the set of generators are controlled by the power management system and configured to adjust the load experienced by the rotor assembly depending on the wind conditions.

16. The wind turbine system of claim 15, further comprising a second rotor assembly on an opposite side of the tower from the other rotor assembly and configured to counter balance the other rotor assembly and a movable platform, wherein the two rotor assemblies are mounted on the movable platform which is configured to move up and down the tower.

17. The wind turbine system of claim 15, wherein the first configuration of the set of generators comprises a first generator connected to the rotor assembly to generate energy.

18. The wind turbine system of claim 17, wherein the second configuration of the set of generators comprises a second generator connected to the rotor assembly to generate energy together with the first generator.

19. The wind turbine system of claim 17, wherein the second configuration of the set of generators comprises a second generator connected to the rotor assembly to generate energy instead of the first generator.

20. The wind turbine system of claim 15, wherein the first configuration of the set of generators comprises a first group of generators connected to the rotor assembly to generate energy.

21. The wind turbine system of claim 17, wherein the second configuration of the set of generators comprises a second group of generators connected to the rotor assembly to generate energy different from the first group of generators.
